(19) United States
(12) Patent Application Publication
(10) Pub. No.: US 2021/0110809 A1
(43) Pub. Date: Apr. 15, 2021

(54) ACOUSTIC ENHANCEMENT DEVICE FOR PRODUCING A REVERBERATION IN A ROOM

(71) Applicant: POWERSOFT S.P.A., 50018 SCANDICCI (FIRENZE) (IT)

(72) Inventor: CLAUDIO LASTRUCCI, LASTRA A SIGNA (IT)

(21) Appl. No.: 17/066,940

(22) Filed: Oct. 9, 2020

(30) Foreign Application Priority Data
Oct. 11, 2019 (IT) 102019000018563

(51) Int. Cl. G10K 15/10; G10K 15/12

(52) U.S. Cl. CPC G10K 15/10; G10K 15/12

(57) ABSTRACT

An acoustic enhancement device (1) for producing a reverberation in a room (100) comprises: a microphone (2) configured to capture an analogue input signal (S1) representing input sounds present in the room (100); a control unit (3), connected to the microphone (2) to receive the analogue input signal (S1), configured to generate a digital signal (SD1) and to process the digital signal (SD1) in real time to generate a digital output signal (SD2); a diffuser (4) connected to the control unit (3) and configured to emit second sounds (41) in the room (100) based on the digital output signal (SD2), wherein the control unit (3) is configured to process the digital signal (SD1) in such a way that the second sounds (41) produce a predetermined reverberation effect in the room (100).

This invention relates to an acoustic enhancement device and method for producing a reverberation in a room.

The invention addresses the field of acoustic enhancement for modifying the acoustic properties of rooms. Known in the prior art in this field are systems designed to simulate in a room (for example, in a home) the ambient acoustic properties of another room (for example, a larger room or an auditorium) by generating an arbitrary reverberation effect. These systems comprise a plurality of microphones which capture the sounds present in the room and transmit them to a control unit, and a plurality of loudspeakers, which are connected to the control unit in order to reintroduce in the room sounds whose properties have been modified compared to the sounds captured by the microphones, and which are such as to produce the arbitrary reverberation effect. The control unit is programmed with algorithms or functions that modify the sound by introducing the reverberation effect. Examples of these systems are described in the following patent documents: U.S. Pat. Nos. 5,729,613A, 5,862,233, 7,233,673B1, 5,109,419A, US9A368101B1 JP2006245670A, U.S. Pat. No. 6,072,879A, JP2007047307A.

In the prior art systems, the microphones must be placed close to the acoustic sources present in the room but far from the loudspeakers so as to capture the sounds in the room but be influenced as little as possible by the sound of the loudspeakers: in effect, placing the microphones close to the loudspeakers would result in what is known as the Larsen (or acoustic feedback) effect whereby the microphone receives the sounds from the loudspeaker and feeds them back to the same loudspeaker, creating a closed loop that produces an unwanted, shrill hissing sound. Placing the microphones far away from the loudspeakers, however, makes the prior art systems very complex: they comprise numerous wiring harnesses connecting each microphone with a main control unit and the main control unit with each loudspeaker. That means the systems are complex to make, install and maintain.

This invention has for an aim to provide an acoustic enhancement device and method for producing a reverberation in a room to overcome at least one of the abovementioned drawbacks of the prior art.

This aim is fully achieved by the device and method of this disclosure as characterized in the appended claims.

According to an aspect of it, this disclosure relates to an acoustic enhancement device for a room. By acoustic enhancement (or acoustic characterization) is meant the modifying of the acoustic properties of a room to simulate the acoustic properties of a room having a different structure and/or size. Typically, a room is characterized by a certain basic reverberation, which depends on its size and shape and on the materials its walls are made of; the device of this disclosure is configured to produce a reverberation that differs from the basic reverberation of the room in order to simulate the acoustics of a different room (for example, of a church or auditorium).

The device comprises an (at least one) microphone configured to capture an analogue input signal representing (input) sounds present in the room. The input sounds include first sounds generated by an acoustic source.

The acoustic source may be, for example, a person, an animal or an electronic appliance (provided with a loudspeaker). The electronic appliance may be outside or inside the device. The electronic appliance may include, for example, a multimedia player, configured to play audio files. The audio files may reside inside the electronic appliance itself, stored in a memory, and/or outside the electronic appliance, stored in a remote database to which the multimedia player is connected (for example, via the Internet or Bluetooth).

The first sounds may also include sounds generated by two or more acoustic sources (for example, a person and an electronic appliance).

Preferably, the acoustic source is located in the room.

The device comprises a control unit. The control unit is connected to the microphone to receive the analogue input signal. Preferably, the control unit is configured to generate a digital signal, representing the analogue input signal; more specifically, the control unit includes an analogue-to-digital converter configured to receive the analogue input signal and to generate the digital signal. In an embodiment, the analogue-to-digital converter may be included in the device but outside the control unit.

The control unit is thus configured to process the digital signal to generate a digital output signal. Preferably, the control unit processes the digital signal in real time. The appliance also includes a digital-to-analogue converter (integrated in the control unit or outside it), configured to generate an analogue output signal based on the digital output signal.

Further, in an embodiment, the control unit may perform processing directly on the analogue signal.

The device comprises an (at least one) diffuser (or loudspeaker) connected to the control unit and configured to emit second sounds in the room, based on the digital output signal. The diffuser receives the analogue output signal from the control unit. The control unit is configured to process the digital signal in such a way that the second sounds produce a predetermined reverberation effect in the room.

The expression “acoustic source” is used to denote any object or subject that is intended to generate sounds and that is separate and distinct from the diffuser of the device. Thus, the diffuser constitutes a further acoustic source, additional to the acoustic source that generates the first sounds.

The control unit is also configured to filter the digital signal in real time to exclude the second sounds from the digital output signal generated (hence from the analogue output signal generated). Thus, the microphone captures sounds that include both the first sounds, generated by the acoustic source, and the second sounds emitted by the diffuser, and sends to the control unit a digital signal representing both the first sounds and the second sounds; the control unit filters the digital signal in such a way as to generate a digital output signal (hence an analogue output signal) from which the second sounds have been cancelled. This prevents the Larsen effect because the sounds emitted by the diffuser, although captured by the microphone, are not fed back to the diffuser recursively but are filtered through the control unit. At the same time, this solution allows the diffuser and the microphone to be positioned freely anywhere in the room, without having to keep them far apart to prevent the Larsen effect.

More specifically, the control unit defines (or includes) a filtering module programmed with a noise cancelling algorithm. The noise cancelling algorithm may be one of the algorithms described in the following prior art documents:
Vedansh Thakkar, “Noise Cancellation using Least Mean Square Algorithm”, IOSR Journal of Electronics and Communication Engineering (IOSR-JECE) e-ISSN: 2278-2834, p-ISSN: 2278-8735, Volume 12, Issue 5, Ver. I (September-October 2017), PP 64-75;
“Review of active noise control algorithms towards a user-implementable aftermarket ANC system”, Marko Stamenovic University of Rochester Department of Electrical and Computer Engineering; “Noise cancellation using adaptive algorithms” Vol. 2, Issue. 3, May-June 2012 pp-79A2-79A5 ISSN: 2249A-6645, Jashvir Chhikara, Jagbir Singh.

The filtering module is configured to receive as input the digital signal and the digital output signal (processed by the control unit) and to process the digital signal as a function of the digital output signal to cancel from the digital signal a contribution of the second sounds. In effect, the digital signal includes both a contribution of the first sounds and a contribution of the second sounds; the digital output signal represents the second sounds; thus, the filtering module receives an indication regarding the second sounds in real time through the digital output signal and processes the digital signal in such a way as to cancel the contribution of the second sounds.

Preferably, the device comprises a shell (or outer casing). The microphone and the diffuser are (both) associated with the shell. By “associated” is meant that the microphone and the diffuser are fixed to the walls of the shell and/or are contained in the shell.

The control unit is preferably contained in the shell. The microphone and the diffuser may be located close together on the shell (for example, at less than 1 metre from each other, or at less than 50 cm or at less than 30 cm). In particular, the shell includes a first face. The first face may have a predetermined orientation. The shell is shaped as a box; preferably, the shell is shaped like a parallelepiped. Preferably, the first face has a planar shape. Preferably, the microphone and the diffuser are both arranged on the first face of the shell. Preferably, the microphone and the diffuser have a same first orientation. Said first orientation can be perpendicular to the first face. So, the microphone can detect sounds coming from a source positioned in a room and the diffuser can emit sounds back towards the same room, in the same direction. In such a way, the quality of sound detection and also the quality of sound diffusion are optimized.

Preferably, the device is configured to be attached on a wall (in particular, a vertical wall). The device is configured to be attached on the wall at a distance from the floor and/or from the ceiling. In particular, the shell includes a second face opposite to the first face and further includes, on the second face, an attachment system configured to attach the device to a wall. Hence, in operation, the first face is directed towards the room. The first orientation along which the microphone and the diffuser are oriented is opposite to the wall; in other words, the first orientation extends from the first face of the shell, perpendicularly to said first face.

The first sounds (emitted by the acoustic source) have a first reverberation time value and the second sounds, emitted by the diffuser, have a second reverberation time value, different from the first value, to produce the predetermined reverberation effect. By reverberation time is meant the time the sound takes to drop to 60 dB below the original sound.

More specifically, in an embodiment, the second reverberation time value is greater than the first reverberation time value (to simulate a larger room where the sound takes longer to bounce back from the wall because the walls are further away).

The control unit defines a reverberation module. The reverberation module is configured to receive the digital signal and to produce a reverberation. In an embodiment, the reverberation module is configured to introduce a predetermined time delay (that is, a phase displacement) in generating the digital output signal. Thus, in an embodiment, the digital output signal corresponds to the digital signal, reproduced in real time after a time delay (with intensity attenuation, if necessary). In an embodiment, the control unit is configured to select the time delay from a plurality of available options.

In an embodiment, the reverberation module is configured to process the digital signal to modify its waveform according to a reverberation function. It should be noted that the reverberation module may be configured both to introduce a time delay and to modify the waveform of the digital signal. The reverberation function (or algorithm) may be one of the types described in the following documents: U.S. Pat. No. 5,862,233, US5729A613, U.S. Pat. No. 7,233,673B1.

In an embodiment, the control unit is configured to select the reverberation function from a plurality of reverberation functions. In an embodiment, the control unit automatically selects a reverberation function (or algorithm); selection may be based on a choice made by the user or on arbitrary criteria stored in the control unit or it may be a random selection made by the control unit.

In an embodiment, the device comprises an interface configured to allow a user to select an acoustic effect (or sound effect) from a plurality of available options. For example, the available options may include a “church” effect, which simulates the acoustics of a church, and a “stadium” effect, which simulates the acoustics of a stadium. The control unit has access to a memory which includes a plurality of reference datasets, where each dataset corresponds to a respective acoustic effect; for example, a reference dataset may include a reverberation function to modify the signal and/or a time delay to delay the signal. The control unit is configured to select from the plurality of reference datasets the reference dataset corresponding to the acoustic effect selected by the user, in order to set the predetermined reverberation effect.

In an embodiment, the device (or the control unit) comprises a buffer; the buffer is configured to temporarily store the data transmitted through the digital signal and/or to slow down the flow of the data. Therefore, the buffer is configured to temporarily store the digital signal. The buffer may be embodied via hardware or software.

This disclosure also provides an acoustic enhancement system for producing a reverberation in a room. The system comprises a plurality of devices according to one or more aspects of this disclosure. Each device of the plurality of devices is placed at a respective position in the room; the control unit of each device is configured to modify a respective input signal to generate a respective predetermined reverberation effect. For example, each device may be set to generate a different reverberation effect, depending on its respective position in the room and/or relative to the other devices.

In an embodiment, the system includes at least a wall (in particular, a vertical wall) delimiting the room, wherein the devices of the plurality of devices are attached to said at least a wall. In particular, each device has a first face, arranged opposite to said at least a wall, wherein the microphone and the diffuser are arranged on said first face. Preferably, the devices are attached on the at least a wall at a predetermined distance from the floor. Preferably, said predetermined distance is the same for all the devices of said plurality. Preferably, said predetermined distance is between 1 m and 3 m (more preferably, between 1.50 m and 2 m). In such a way, the microphone and the diffuser are located at more or less the same height as a face of a person standing (or sitting) in the room, so that the reverberation effect is very realistic. Preferably, the devices are attached on the at least a wall at a distance from the ceiling.

It should be noted that the system according to this disclosure is distinguished by considerable simplicity of construction. In effect, the system includes a plurality of devices which need not be interconnected with each other: each device includes a respective microphone, a respective control unit and a respective diffuser; the second sounds emitted by the diffusers of the devices cooperate to produce an overall reverberation effect in the room (without necessitating a main control unit connected to all the microphones and all the diffusers).

This disclosure also provides an acoustic enhancement method for producing a reverberation in a room. The method is implemented preferably by an acoustic enhancement device (or system). The device (or the system) may include one or more of the features described in this disclosure.

The method comprises a step of receiving an analogue input signal in a control unit. The input signal represents the input sounds present in the room; the input sounds include first sounds generated by an acoustic source outside the device and located in the room.

The method comprises a step of generating a digital signal, representing the analogue input signal.

The method comprises a step of processing the digital signal in the control unit in real time to generate a digital output signal representing second sounds. In the step of processing, the control unit processes the digital signal in such a way that the second sounds produce a predetermined reverberation effect in the room. Thus, the input sounds also include the second sounds. The method also comprises a step of converting the digital output signal into an analogue output signal.

The method (specifically the step of processing) comprises a step of filtering the digital signal in real time to exclude the second sounds from the digital output signal generated. The step of filtering includes a step of processing the digital signal as a function of the digital output signal to cancel from the digital signal a contribution of the second sounds. This step of processing is performed by a filtering module programmed with a noise cancelling algorithm.

The first sounds have a first reverberation time value and the second sounds, emitted by the diffuser, have a second reverberation time value, different from the first value (in an embodiment, greater than the first value), to produce the predetermined reverberation effect.

In an embodiment, the method (specifically the step of processing) comprises a step of reverberating the digital signal to produce the predetermined reverberation effect in the room. In an embodiment, the step of reverberating includes a sub-step of introducing a predetermined time delay in generating the digital output signal. More specifically, in an embodiment, the step of reverberating includes reproducing the time-delayed digital signal (with intensity attenuation, if necessary).

In an embodiment, the step of reverberating includes processing the digital signal to modify its waveform according to a reverberation function. In an embodiment, the method comprises a step of selecting the reverberation function from a plurality of reverberation functions.

The step of reverberating may include, alternatively or in combination, the sub-step of introducing the time delay and/or the sub-step of processing the signal to modify its waveform.

In an embodiment, the method comprises a step of a user selecting an acoustic effect from a plurality of available options. Thus, the method comprises a step of querying a memory (or database) including a plurality of reference datasets, where each dataset corresponds to a respective acoustic effect, to retrieve the reference dataset corresponding to the acoustic effect selected by the user. In the step of reverberating, the reverberation function and/or the predetermined time delay are determined by the reference dataset.

This disclosure also provides a computer program comprising operating instructions configured to perform the steps of the method according to one or more aspects of this disclosure (specifically when carried out in a control unit of a device according to one or more aspects of this disclosure.

These and other features will become more apparent from the following description of a preferred embodiment, illustrated by way of non-limiting example in the accompanying drawings, in which:

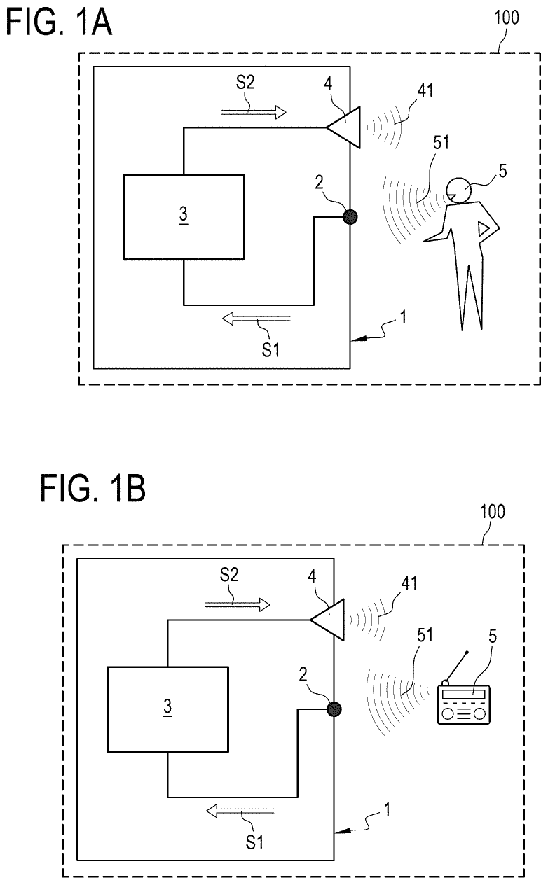

FIGS. 1A, 1B, 1C and 1D schematically illustrate an acoustic enhancement device according to one or more aspects of this disclosure;

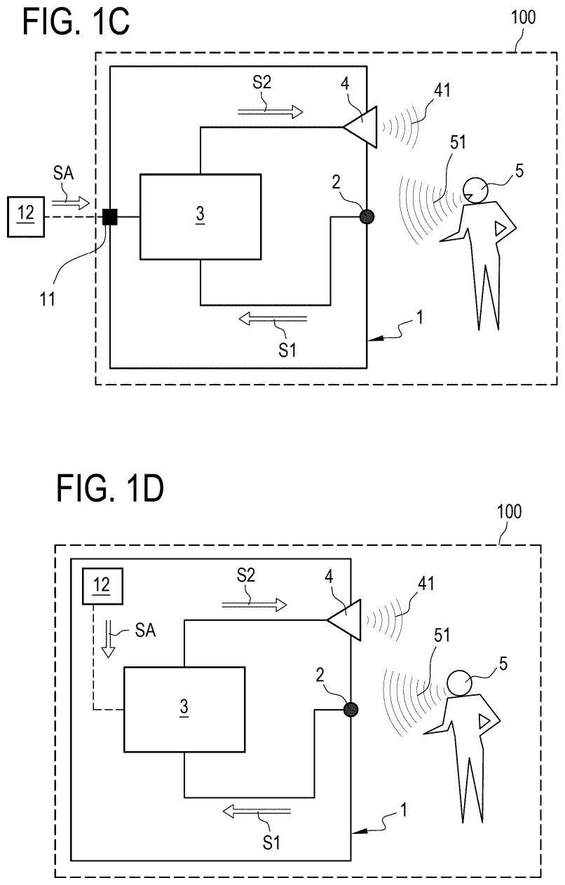

FIGS. 2A and 2B illustrate the control unit of the device of FIG. 1A according to respective embodiments;

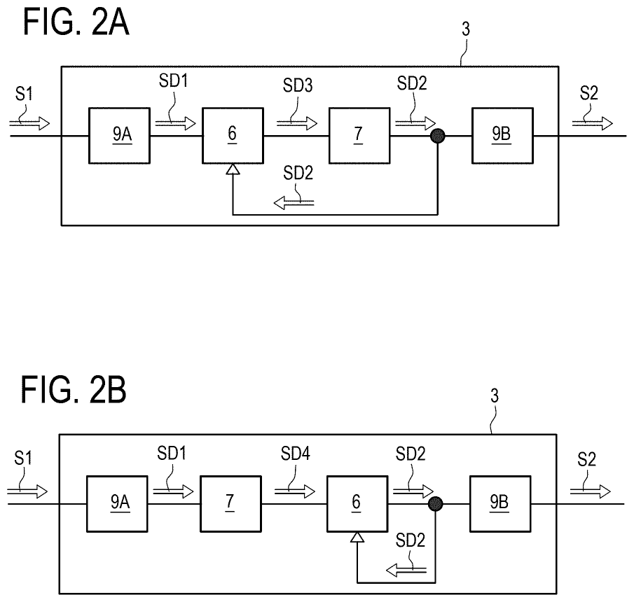

FIG. 3 illustrates the device of FIG. 1A in a perspective view;

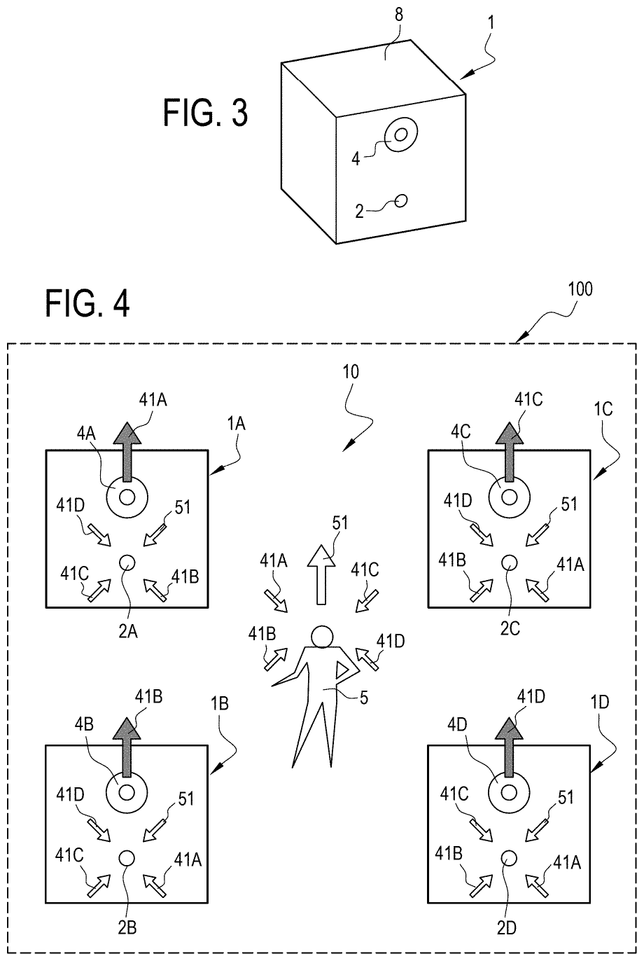

FIG. 4 illustrates an acoustic enhancement system including a plurality of devices according to FIG. 1A.

With reference to this disclosure, the numeral 1 denotes an acoustic enhancement device for producing a reverberation in a room 100.

The device 1 includes a microphone 2. The microphone 2 is configured to capture an analogue input signal S1 representing input sounds present in the room 100. The input sounds include first sounds 51 generated by an acoustic source 5 located in the room 100.

The acoustic source 5 may include a person present in the room 100; the acoustic source 5 may include an electronic appliance (provided with a loudspeaker) present in the room 100. More specifically, the electronic appliance may include (or be connected to) a multimedia player configured to read audio files; the electronic appliance may include (or be connected to) a radio receiver configured to tune in to radio channels. In these embodiments, the electronic appliance is configured to emit the first sounds 51 on the basis of the audio files read by the multimedia player and/or of the signals received by the radio receiver.

It should be noted that the acoustic source 5 and the device 1 are both preferably located in the room 100.

The device 1 includes (or defines) a control unit 3. The control unit 3 is connected to the microphone 2 to receive the analogue input signal S1.

The control unit 3 is configured to generate an analogue output signal S2.

The device 1 includes a diffuser 4. The diffuser 4 is connected to the control unit 3 to receive the analogue output signal S2. The diffuser 4 is configured to emit second sounds 41 in the room 100 based on the digital output signal S2. The input sounds (received by the microphone 2) include both the first sounds 51 and the second sounds 41.

Preferably, the device 1 comprises a shell configured to be attached on a wall. The diffuser 4 and the microphone 2 are integrated in the shell. In particular, the shell is substantially shaped as a parallelepiped having a first face and a second face opposite to the first face; the second face is configured to be attached on a wall of the room; the first face faces the room. The diffuser 4 and the microphone 2 are arranged on the first face, so that they are both directed towards the room.

Preferably, the first face is oriented vertically (parallel to the wall); preferably, also the second face is oriented vertically (parallel to the wall). The first (and/or the second) face has a height, defined in a vertical direction, and a width, defined in a horizontal direction perpendicular to the vertical direction; preferably, the height is less than the double, or the triple, of the width. Also, the shell has a depth, perpendicular to the first and to the second face; the depth is preferably less than half of the width.

In an embodiment, the device 1 includes a first diffuser 4A and a second diffuser 4B; the first diffuser 4A is configured to emit sounds at high frequencies, and the second diffuser 4B is configured to emit sounds at low frequencies (or vice versa). What is disclosed with regard to the diffuser 4 applies, mutatis mutandis, to the first and second diffusers 4A and 4B. In particular, both the first diffuser 4A and the second diffuser 4B are arranged on the first face of the shell. In an illustrated embodiment, the microphone 2 has a diameter which is lower than the diameter of the first diffuser 4A and the second diffuser 4B; the diameter of the first diffuser 4A is lower than the diameter of the second diffuser 4B; the first diffuser 4A is located at a same height than the microphone 2, while the second diffuser 4B is located below the first diffuser 4A and the microphone 2.

The control unit 3 includes an analogue-to-digital converter (or sampling unit) 9A, configured to receive the analogue input signal S1 and to digitize the analogue input signal S1 to generate a digital input signal SD1.

The device 1 includes a digital-to-analogue converter 9B, configured to receive a digital output signal SD2 and to generate an analogue output signal S2 therefrom. Preferably, the digital-to-analogue converter 9B is integrated in the control unit 3. It should be noted, however, that in an embodiment, the digital-to-analogue converter 9B may be integrated in the diffuser 4; in this embodiment, the control unit 3 transmits to the diffuser 4 the digital output signal SD2, which is converted into the analogue output signal S2 by the diffuser 4 itself.

The control unit 3 includes (or defines) a filtering module 6. The control unit includes (or defines) a reverberation module 7. The filtering module 6 may be connected upstream or downstream of the reverberation module 7.

In an embodiment, the filtering module 6 is connected to the analogue-to-digital converter 9A (or to the buffer) to receive the digital input signal SD1. Also, the filtering module 6 is configured to receive the digital output signal SD2 (or an information item representing the digital output signal SD2). The filtering module 6 is configured to process the digital input signal SD1 as a function of the digital output signal SD2 to cancel from the digital input signal SD1 a contribution of the second sounds 41. In effect, the digital input signal SD1 includes a first component, representing the first sounds 51, and a second component, representing the second sounds 41; the digital output signal SD2 represents the second sounds 41. Thus, the filtering module 6 is configured to cancel the second component from the digital input signal SD1 using a noise cancelling algorithm which processes the digital input signal SD1 as a function of the digital output signal SD2. Thus, the filtering module 6 is configured to generate a filtered digital signal SD3; the filtered digital signal SD3 represents the first component of the digital input signal SD1. In this embodiment, the reverberation module 7 is connected to the filtering module 6 to receive the filtered digital signal SD3 from the filtering module 6. The reverberation module 7 is configured to generate the digital output signal SD2, where the digital output signal SD2 is such that the second sounds produce a predetermined reverberation effect in the room 100. More specifically, the reverberation module 7 is configured to introduce into the filtered digital signal SD3 a predetermined time delay and/or to process the filtered digital signal SD3 to modify its waveform according to a reverberation function. In this embodiment, the reverberation module 7 is connected to the digital-to-analogue converter 9B to transmit the digital output signal SD2 to the digital-to-analogue converter 9B.

In an embodiment, the reverberation module 7 is connected to the analogue-to-digital converter 9A (or to the buffer) to receive the digital input signal SD1. The reverberation module 7 is configured to introduce into the digital input signal SD1 a predetermined time delay and/or to process the digital input signal SD1 to modify its waveform according to a reverberation function. Thus, the filtering module 7 is configured to generate a reverberated digital signal SD4; the reverberated digital signal SD4 is such as to produce the predetermined reverberation effect and includes both a first component, representing the first sounds 51, and a second component, representing the second sounds 41. In this embodiment, the filtering module 6 is connected to the reverberation module 7 to receive the reverberated digital signal SD4 from the reverberation module 7; also, the filtering module is configured to receive the digital output signal SD2 (or an information item representing the digital output signal SD2). Thus, the filtering module 6 is configured to cancel the second component from the reverberated digital signal SD4 using a noise cancelling algorithm which processes the reverberated digital signal SD4 as a function of the digital output signal SD2. Thus, the filtering module 6 is configured to generate the digital output signal SD2, which represents the first component of the reverberated digital signal SD4. In this embodiment, the filtering module 6 is connected to the digital-to-analogue converter 9B to transmit the digital output signal SD2 to the digital-to-analogue converter 9B.

Thus, the control unit 3 is configured not only for filtering but also for reverberating the (digital) signal; filtering may be performed without distinction either before or after reverberation. Through the filtering module 6, the control unit 3 is able to discriminate the first sounds 51, produced by the acoustic source 5, and the second sounds 41, produced by the diffuser; through the reverberation module 7, the control unit 3 is able to generate the predetermined reverberation effect (that is, to process the digital signal in such a way to modify the reverberation time of the second sounds 41 emitted by the diffuser 4).

Preferably, the device 1 includes un box-shaped body 8. The microphone 2, the control unit 3 and the diffuser 4 are associated with (or contained in) the box-shaped body 8.

Where the acoustic source 5 includes an electronic appliance provided with a loudspeaker, configured to emit the first sounds, the electronic appliance may form part of the device 1 and be integrated in the box-shaped body 8. The loudspeaker of the electronic appliance defining the acoustic source 5 is preferably distinct from the diffuser 4 of the device 1.

Preferably, the device 1 comprises a buffer, configured for temporarily storing the data transmitted through the digital signal. Preferably, the buffer is integrated in the control unit 3.

More specifically, in the embodiment where the filtering module 6 is located upstream of the reverberation module 7, the buffer may be located between the analogue-to-digital converter 9A and the filtering module 6, to temporarily store the data transmitted through the digital input signal SD1; the buffer may also be located between the filtering module 6 and the reverberation module 7 to temporarily store the data transmitted through the filtered digital signal SD3.

In the embodiment where the filtering module 6 is located downstream of the reverberation module 7, the buffer may be located between the analogue-to-digital converter 9A and the reverberation module 7, to temporarily store the data transmitted through the digital input signal SD1; the buffer may also be located between the reverberation module 7 and the filtering module 6 to temporarily store the data transmitted through the reverberated digital signal SD4.

In an embodiment, the device 1 comprises an interface (associated with the box-shaped body 8 or separate therefrom), configured to allow a user to select an acoustic effect from a plurality of available options. The control unit 3 is connected to the interface and is configured to select the reverberation function and/or the predetermined time delay as a function of the selection made by the user.

In an embodiment, the control unit 3 may also be configured to receive an audio input signal SA generated by an audio source 12. By audio input signal SA is meant a signal transmitted by the audio source 12 to the processor 3 without passing through the microphone 2. The audio signal SA may be an analogue signal or a digital signal.

The audio source 12 may be connected to the device 1; in effect, the device 1 may be provided with an audio input port 11 to receive the audio input signal SA and to transmit it to the processor 3.

The audio source 12 may be inside the device 1. More specifically, the device 1 may include an audio player with resident files, an FM receiver, a Bluetooth receiver and/or a Wi-Fi receiver.

The control unit 3 is configured to perform on the audio input signal SA one or more of the operations described with reference to the analogue input signal S1 (or the digital input signal SD1). More specifically, the control unit 3 may be configured to treat the audio input signal SA in the same way as the analogueue input signal S1 or the digital input signal SD1. More specifically, the control unit 3 may be configured to reverberate the audio input signal SA to generate the output signal SD2 which is sent to the diffuser 4; in this context, the control unit 3 might also be configured to digitize the audio input signal SA (if it is an analogue signal) and, if necessary, also to filter the audio input signal SA.

Therefore, the analogue input signal S1 or the digital input signal SD1 may also include the audio input signal SA in addition to the signal (that is, the contribution) representing the input sounds.

This disclosure also provides an acoustic enhancement system 10 comprising a plurality of acoustic enhancement devices 1A, 1B. 10, 1D. Each device 1A, 1B, 10, 1D is a device 1 of the type described above.

More specifically, each device 1A, 1B, 10, 1D comprises a respective microphone 2A, 2B, 2C, 2D, a respective control unit and a respective diffuser 4A, 4B, 4C, 4D. The diffusers 4A, 4B, 4C, 4D emit respective second sounds 41A, 41B, 410, 41D, each having a respective predetermined reverberation effect. The microphone 2A of the device 1A captures the second sounds 41A, 41B, 41C. 41D and the first sounds 51; the control unit of the device 1A filters the second sounds 41A emitted by the device 1A. Similarly, the microphones 2B, 2C, 2D of the devices 1B, 10, 1D capture the second sounds 41A, 41B, 41C, 41D and the first sounds 51; the control unit of the device 1B filters the second sounds 41B emitted by the device 1B; the control unit of the device 1C filters the second sounds 41C emitted by the device 1C; the control unit of the device 1D filters the second sounds 41D emitted by the device 1D.

The system 10 generates in the room 100 an overall reverberation effect which is determined by the second sounds 41A, 41B, 410, 41D emitted by the device 1A, 1B, 10 and 1D (hence by the reverberation effects produced by the devices 1A. 1B, 10 and 1D). Each device 1A. 1B, 10, 1D produces a respective reverberation effect as a function of its spatial location in the room 100.

This disclosure also relates to an acoustic enhancement method for producing a reverberation in a room 100. The method is preferably implemented by an acoustic enhancement device 1 (or an acoustic enhancement system 10 comprising a plurality of acoustic enhancement devices 1A, 1B, 10, 1D).

The method comprises a step of capturing input sounds present in the room 100 through a microphone 2. The input sounds include first sounds 51 generated by an acoustic source 5 located outside the device 1 and inside the room 100.

The method comprises a step of receiving an analogue input signal S1 in a control unit 3. The method comprises a step of processing the analogue input signal S1 in the control unit 3 in real time to generate an analogue output signal S2. The analogue output signal S2 represents the second sounds 41.

The method comprises a step of emitting the second sounds 41 in the room 100 to produce a predetermined reverberation effect; the second sounds 41 are emitted by a diffuser 4, connected to the control unit 3 to receive the analogue output signal S2.

The method (that is, the step of processing) comprises a step of digitizing the analogue input signal S1 through an analogue-to-digital converter 9A to generate a digital input signal SD1. The digital input signal SD1 includes a first component, representing the first sounds 51, and a second component, representing the second sounds 41.

In an embodiment, the method (that is, the step of processing) comprises a step of receiving the digital input signal SD1 in a filtering module 6 and a step of filtering the digital input signal SD1 in real time, through the filtering module 6, to generate a filtered digital signal SD3; the filtering module 6 receives a digital output signal SD2 and cancels from the digital input signal SD1 the second component representing the second sounds 41. In this embodiment, the method (that is, the step of processing) comprises a step of receiving the filtered digital signal SD3 in a reverberation module 7 and a step of reverberating the filtered digital signal SD3 to generate a digital output signal SD2; the step of reverberating causes the second sounds 41 emitted by the diffuser 4 to have a second reverberation time value, different from a first value of the first sounds 51; that way, the second sounds 41 produce the predetermined reverberation effect in the room 100. More specifically, the step of reverberating may include introducing into the filtered digital signal SD3 a predetermined time delay and/or processing the filtered digital signal SD3 to modify its waveform according to a reverberation function.

In an embodiment, the method (that is, the step of processing) comprises a step of receiving the digital input signal SD1 in the reverberation module 7 and a step of reverberating the digital input signal SD1 to generate a reverberated digital signal SD4. More specifically, the step of reverberating may include introducing into the reverberated digital signal SD4 a predetermined time delay and/or processing the reverberated digital signal SD4 to modify its waveform according to a reverberation function. The reverberated digital signal SD4 (like the digital input signal SD1 and the analogue input signal S1) includes a first component, representing the first sounds 51, and a second component, representing the second sounds 41. In this embodiment, the method comprises a step of receiving the reverberated digital signal SD4 in the filtering module 6 and a step of filtering the reverberated digital signal SD4 through the filtering module 6. The filtering module 6 also receives the digital output signal SD2 in real time and processes the reverberated digital signal SD4 as a function of the digital output signal SD2 to cancel the second component of the reverberated digital signal SD4. Thus, in this embodiment, the filtering module 6 generates as its output the digital output signal SD2. The digital output signal SD2 is converted by a digital-to-analogue converter 9B into the analogue output signal S2 that is sent to the diffuser 4.

Therefore, it should be noted that the step of filtering may precede or follow the step of reverberating.

1. An acoustic enhancement device for producing a reverberation in a room, the device comprising:
a microphone configured to capture an analogue input signal representing input sounds present in the room, the input sounds including first sounds generated by an acoustic source located in the room;
a control unit, connected to the microphone to receive the analogue input signal, configured to generate a digital signal representing the analogue input signal and programmed to process the digital signal in real time to generate a digital output signal;
a diffuser connected to the control unit and configured to emit second sounds in the room based on the digital output signal,
wherein the control unit is configured to process the digital signal in such a way that the second sounds produce a predetermined reverberation effect in the room,
wherein the control unit is configured to filter the digital signal in real time to exclude the second sounds from the digital output signal generated.

2. The device according to claim 1, wherein the control unit defines a filtering module programmed with a noise cancelling algorithm and configured to receive as input the digital signal and the digital output signal and to process the digital signal as a function of the digital output signal to cancel from the digital signal a contribution of the second sounds.

3. The device according to claim 1, comprising a shell, wherein the microphone and the diffuser are both associated with the shell.

4. The device according to claim 3, wherein the shell includes a first face having a predetermined orientation and wherein the microphone and the diffuser are both arranged on the first face of the shell.

5. The device according to claim 4, wherein the microphone and the diffuser have a same first orientation, said first orientation being perpendicular to the first face.

6. The device according to claim 3, wherein the shell includes a second face opposite to the first face and further includes, on the second face, an attachment system configured to attach the device to a wall.

7. The device according to claim 1, wherein the first sounds have a first reverberation time value and the second sounds, emitted by the diffuser, have a second reverberation time value, different from the first value, to produce the predetermined reverberation effect.

8. The device according to claim 4, wherein the second reverberation time value is greater than the first reverberation time value.

9. The device according to claim 1, wherein the control unit defines a reverberation module, configured to introduce a predetermined delay time in generating the digital output signal.

10. The device according to claim 9, wherein the control unit is configured to select said predetermined delay time among a plurality of possible options, as a function of an input received by a user.

11. The device according to claim 1, wherein the control unit defines a reverberation module, configured to process the digital signal to modify its waveform according to a reverberation function.

12. The device according to claim 11, wherein the control unit is configured to select the reverberation function from a plurality of reverberation functions.

13. The device according to claim 1, comprising an interface configured to allow a user to select an acoustic effect from a plurality of available options, wherein the control unit has access to a memory including a plurality of reference datasets, wherein each dataset corresponds to a respective acoustic effect and wherein the control unit is configured to select, from the plurality of reference datasets, the reference dataset corresponding to the acoustic effect selected by the user.

14. The device according to claim 1, comprising a buffer, configured to temporarily store the data transmitted through the digital signal or to slow down the flow of the data.

15. An acoustic enhancement system for producing a reverberation in a room, the system comprising a plurality of devices according to claim 1, wherein each device of the plurality of devices is located at a respective position inside the room, and wherein the control unit of each device is configured to modify a respective input signal to generate a respective predetermined reverberation effect.

16. The acoustic enhancement system according to claim 15, wherein the system includes at least a wall delimiting the room, wherein the devices of the plurality of devices are attached to said at least a wall at a distance from a floor.

17. An acoustic enhancement method for producing a reverberation in a room by means of an acoustic enhancement device, the method comprising the following steps:
receiving an analogue input signal in a control unit, wherein the analogue input signal represents input sounds present in the room, the input sounds including first sounds generated by an acoustic source located in the room;
generating a digital signal, representing the analogue input signal;
processing the digital signal in the control unit in real time to generate a digital output signal representing second sounds;
wherein in the step of processing, the control unit processes the digital signal in such a way that the second sounds produce a predetermined reverberation effect in the room,
wherein the method further comprises a step of filtering the digital signal (SD1) in real time to exclude the second sounds (41) from the digital output signal (S2) generated.

18. The method according to claim 17, wherein the step of filtering includes processing the digital signal as a function of the digital output signal to cancel from the digital signal a contribution of the second sounds, by means of a filtering module programmed with a noise cancelling algorithm.

19. The method according to claim 17, comprising a step of reverberating the digital signal to produce the predetermined reverberation effect in the room, the step of reverberating including one or more of the following sub-steps:
introducing a predetermined time delay in generating the digital output signal;
processing the digital signal to modify its waveform according to a reverberation function.

20. A computer program comprising operating instructions configured to perform the steps of the method according to claim 17, when carried out in a control unit of an acoustic enhancement device for producing a reverberation in a room, the device comprising:
a microphone configured to capture an analogue input signal representing input sounds present in the room, the input sounds including first sounds generated by an acoustic source located in the room;
a control unit, connected to the microphone to receive the analogue input signal, configured to generate a digital signal representing the analogue input signal and programmed to process the digital signal in real time to generate a digital output signal;
a diffuser connected to the control unit and configured to emit second sounds in the room based on the digital output signal,
wherein the control unit is configured to process the digital signal in such a way that the second sounds produce a predetermined reverberation effect in the room,
wherein the control unit is configured to filter the digital signal in real time to exclude the second sounds from the digital output signal generated.
